(19) United States
(12) Patent Application Publication
(10) Pub. No.: US 2017/0294954 A1
(43) Pub. Date: Oct. 12, 2017

(54) Polarization Modulation

(71) Applicant: Paul William Gorman, Longmeadow, MA (US)

(72) Inventor: Paul William Gorman, Longmeadow, MA (US)

(21) Appl. No.: 15/093,572

(22) Filed: Apr. 7, 2016

(51) Int. Cl. H04B 7/10; H04B 1/38

(52) U.S. Cl. CPC H04B 7/10; H04B 1/38

(57) ABSTRACT

This utility patent is for the encoding of information that utilizes more than one electromagnetic polarized wave (radio wave or optical wave) from a single location and over a single frequency in which each of the electromagnetic polarized waves are independently adjusted in signal strength. The combined electromagnetic waves are then received at a single location and decoded.

Combined electromagnetic waves pertains to using more than one electromagnetic wave in a mathematical formula with all electromagnetic waves being included in the formula. Single frequency, pertaining to this patent application Ser. No. 15/093,572 pertains to what is commonly referred to as the carrier frequency. The modulation from each of the antennas independently can be in the form of Amplitude Modulation, Frequency Modulation, Frequency-Shift Keying, or other modulations.

### DESCRIPTION OF DRAWINGS

FIG. 1: Two antennas at a single location, where one antenna transmits a horizontal polarized electromagnetic wave and the other antenna transmits a vertical polarized electromagnetic wave at a single location. The receiving of the intelligence uses the same antenna design at another single location. The electromagnetic wave receiver antennal orientation must approximately match that of the transmitter (ie. as close as possible for the best reception). The electromagnetic wave received is strongest at the closest matching antenna (as far as antenna orientation that is).

FIG. 2: This is the same concept as in FIG. 1, however both antennas are at a slight angle to the vertical axis. The electromagnetic wave received is strongest at the closest matching antenna (as far as orientation that is).

FIG. 3: This is the same concept as in FIG. 2, however, this design is in the horizontal orientation. A single location is defined as a physical location where all of the intelligence information is contained.

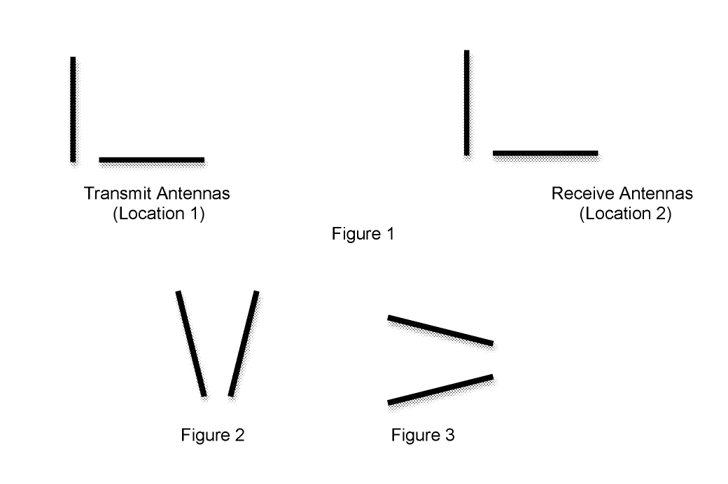

### DETAIL DESCRIPTION

This patent is intended for communications between multiple locations by the transmission of electromagnetic waves (radio waves) that are polarized in different orientations (from a single location) and transmitted at the same or near same time, so that the intelligence and/or information is conveyed at a receiver or multiple receivers. In prior art (pertaining to radio wave modulation methods), intelligence was transmitted by varying either the strength of the electromagnetic wave (generally known as Amplitude Modulation) or changing the carrier frequency (generally known as Frequency Modulation). Other, more modern modulation methods are variations of the Amplitude and Frequency Modulations, but do not utilized or encode the information using the multiple orientations of electromagnetic waves during a single transmission.

While studying antenna design and radio transmission systems, transceivers (ie. combined transmitter and receiver) work the best when the polarization (generally horizontal, vertical, or circular in propagation) of the electromagnetic waves that matches at both the transmitting and receiving locations (ie. using the same antenna orientation at the transmitter and the receiver). This patent utilizes the fact that there is a difference in the electromagnetic signal strength of the two or more antennas based upon the fact that they are in different orientations. Each antenna has it's own independent transmitter at the sending end of the information and a separate receiver for each antennas at the receiving end.

Staggering of multiple electromagnetic wave (radio wave) frequencies in which information is conveyed through the use of the combined multiple electromagnetic wave frequencies. In this claim [0002], conveyed information is transmitted using two or more frequencies at the same electromagnetic wave orientation (or very close) from a single location and received at another location (being one or more locations). The information can then be combined in conjunction with other transmitted electromagnetic wave (radio wave) in other electromagnetic wave orientations in claim [0003].

1. A radio transmitters and/or receivers at a single location, comprising of the either sending and/or receiving intelligence on a single radio frequency by utilizing two or more antennas at different orientations at a single location; where the polarized signal has the strongest signal strength at the closest matching orientated antenna. Transmission of the electromagnetic waves transmitted by each of the antennas can be simultaneous or close in time at the same radio frequency (without electronically switching between the antennas with a single transmitter or the use of a third electromagnetic wave that may have been generated). The strength of the electromagnetic wave differences between the antennas grouped together at the single location is how the intelligence is transferred from location to location. Hence, polarized modulation. The radio transmitters vary the electromagnetic signal strength at each antenna in accordance with the intelligence that is being communicated from one location to another. The receivers at the receiving end of the intelligence use the difference in electromagnetic signal strength to decipher the intelligence.

2. Staggering of electromagnetic waves frequencies in the same orientation using multiple frequencies in which information is conveyed as a combination of the electromagnetic waves.

3. Encoding of conveyed information across multiple electromagnetic wave frequencies using multiple electromagnetic wave orientations.

4. Use of the electromagnetic antennas being in a cable form, such as coax cable. Cables, such as Twixaxial, comprising of multiple wires within it and the use of the combined signals of all the wires (ie. Not in a push-pull configuration such as one wire being the sender of a signal and the other wire being the receiving wire of the same signal).

5. Separate electrical wire or cables (ie. Coax cable), that are a fixed distance apart, and where the combined electromagnetic signals from each of the wires are combined (ie. Not used independently from a hardware perspective).

6. Combined electromagnetic waves (ie. Light waves) contained in a optical cable.
